(19) United States
(12) Patent Application Publication
(10) Pub. No.: US 2016/0269846 A1
(43) Pub. Date: Sep. 15, 2016

(54) DERIVATION OF MULTICHANNEL SIGNALS FROM TWO OR MORE BASIC SIGNALS

(71) Applicant: STORMINGSWISS GMBH, Morges (CH)

(72) Inventor: Clemens Par, Cinuos-chel (CH)

(21) Appl. No.: 15/026,735

(22) PCT Filed: Oct. 2, 2014
(86) PCT No.: PCT/EP2014/071146

§ 371 Date: May 27, 2016

(30) Foreign Application Priority Data
Oct. 2, 2013 (CH) 1696/13
Oct. 9, 2013 (CH) 01727/13

(51) Int. Cl. H04S 5/00; G10L 19/008

(52) U.S. Cl. CPC H04S 5/00; G10L 19/008; H04S 2400/03; H04S 2420/07

(57) ABSTRACT

Direct extraction of multichannel signals using correlation comparison, which firstly provides its mathematically exact solution for time-invariant (steady-state) signals, and has a specific residual response in the case of time-variant (non-steady-state) signals, results in direct verification of a signal that forms the basis of all residuals and that is very simple to determine. This can be used in audio coding, for example, for efficiently reducing artifacts or colourations of the tone and other de-masking effects and results in efficient coding of signals of the highest order (such as NHK 22.2).

Multichannel signals and, in particular, three-dimensional signals such as audio signals, for example, make stringent requirements of volumes of data to be transmitted or to be stored, which need to be reduced as efficiently as possible.

Generally known devices or methods for such data reduction here are parametric methods that extract spatial information for example with the aid of the Fast Fourier Transform (FFT) known from the prior art and then transmit it as a permanent data stream, for instance jointly with a mono or stereo signal as a downmix signal. Such an audio technology is known in particular with MPEG surround and, considered mathematically, constitutes an adaptive filtering method.

A pseudostereophonic method is the inverse coding (a solution of inverse problems in the case of spatial audio signals) which, on the basis of geometrical parameters, calculates the division of the signal components between a left and a right channel or between a side and a main signal from a mono signal. Appropriate geometrical parameters are e.g. the angle between a sound source and a principal axis of a microphone and/or a fictitious opening angle of the microphone and/or a fictitious left opening angle of the microphone and/or a fictitious right opening angle and/or a directional characteristic of the microphone. These parameters either can be concomitantly transmitted with the downmix signal or can be chosen to be fixed depending on the parameters used in the downmix, or can also be defined as default values. An inverse coding is disclosed in WO2009138205, for example.

A correlation comparison of two channels is a further possibility for obtaining a third channel of an upmix signal. In this case, the common signal components of both channels are determined, and a further channel of the upmix signal is determined therefrom. By way of example, devices or methods known from the prior art such as, for example, the upmix system UPM1 from the British company Soundfield, which is based on the Fast Fourier Transform (FFT), could be used for determining the common signal components. However, this requires a very high computational complexity. The output signals here are formed in an amplitude-dependent manner, which entails the disadvantage of drifting sound sources and temporally shifting artifacts on the individual channels, and leads overall to significant spectral colorations that have a disturbing effect in the field of audio coding.

A simple device or a simple method for such a correlation comparison which additionally fulfils the aim of the highest possible psychoacoustic transparency would accordingly be desirable for example with regard to the coding of multichannel signals in real time.

If such a simple device or a simple method, as is the case for the present invention, is based on a Fourier transform applied to temporally varying (“non-steady-state”) signals, so-called residuals occur. In this case, it is desirable to be able to determine these residuals in an encoder so generally that not all of the residuals have to be transmitted, which results in a significant saving of bandwidth for example in audio coding.

Accordingly, the present invention is intended to present a simple device or a simple method that accomplishes such a correlation comparison with very high transparency. The present invention is not restricted to audio signals, although such a system can be optimally applied to audio signals, in particular. In this regard, with the subject matter of the invention, for instance, video signals can be efficiently compressed and decompressed—or their residuals can be efficiently minimized.

Generally, the subject matter of the invention can be applied in the entirety of signal technology if the latter is based on a Fourier transform or an inverse Fourier transform, and results there for example in a drastic saving of bandwidth or enables an efficient data extraction.

With the present invention, in audio coding, for example, the number of downmix channels can be restricted to a minimum since the admixed channels can again be isolated by correlation comparison and thus enable overall an efficient storage and transmission of high-complexity audio signals.

In particular, such high-complexity 3D audio signals, as are known for example with the format NHK 22.2, can now be combined into corresponding downmix channels which in part or overall can again be subjected to such a correlation comparison.

By way of example, the Middle Layer and the Top Layer of an NHK-22.2 system (or of a similar format) can be subjected to such correlation comparisons separately, since psychoacoustically horizontal planes are perceived substantially separately, and the formation of phantom sound sources occurs only to a small extent between said planes, that is to say in the vertical, diagonal, etc.

Accordingly, it is particularly advantageous to apply such correlation comparisons within horizontal planes. In particular, it is advantageous, even if the invention is not restricted thereto, to perform such correlation comparisons on adjacent channels, since, in the case of high-order signals, a strict channel separation forms a basic prerequisite for the clean formation of phantom sound sources.

Of course, the invention is not restricted to the horizontal, rather vertical or diagonal or other combinations can also be used.

The following documents should be considered in particular as associated with the prior art:

EP1850639 describes a static filter that generates a stereo signal from a mono signal. This filter can also be applied to multichannel signals.

WO2009138205 describes a static filter that generates a stereo signal from a mono signal. This filter can also be applied to multichannel signals.

WO2011009649 describes an extension of the static filters described in EP1850639 and WO2009138205 for adapting the degree of correlation of the stereo signal respectively generated. This extension can also be applied to multichannel signals.

WO2011009650 describes extensions of the devices or methods described in EP1850639 and WO2009138205 and WO2011009649 in order to optimize the stereo signal respectively generated with regard to the static parameters. These extensions can also be applied to multichannel signals.

WO2012016992 describes the first practical use of algebraic invariants generally in signal technology and in particular in relation to EP1850639, WO2009138205, WO2011009649 and WO2011009650.

WO2012032178 describes the temporal scaling of static filters in accordance with EP1850639, WO2009138205, WO2011009649, WO2011009650 and WO2012016992.

The present applicant's unpublished application CH02300/12, which is briefly illustrated by way of example with reference to FIG. 9, describes extensions of said static filters for the targeted application thereof to multichannel signals, with this including the application of direct correlation comparison, which can take place for example directly using the upmix system UPM1 from the British company Soundfield.

HAMASAKI KIMIO ET AL.: “The 22.2 Multichannel Sound System and Its Application”, AES CONVENTION 118, MAY 2005, describes a channel-based reproduction format of very high order and spatial resolution.

MPEG Surround defines as a standard the use of so-called parametric methods for transmitting multichannel signals on the basis of a mono or stereo signal.

### DISCLOSURE OF THE INVENTION

The present applicant's unpublished application CH02300/12, see FIG. 9 and below, proposes an extraction of multichannel signals with the aid of correlation comparison; however, the document does not specify an explicit technical solution for such a correlation comparison, since devices or methods known from the prior art exist.

Such a correlation comparison is accomplished by, for example, the upmix system UPM1 from the British company Soundfield, which, likewise on the basis of the Fast Fourier Transform (FFT, see below), overall requires a high computational complexity. The output signals here are formed, however, in an amplitude-dependent manner, which entails the disadvantage of drifting sound sources and temporally shifting artifacts on the individual channels, and leads overall to significant spectral colorations that have a disturbing effect in the field of audio coding.

Such a correlation comparison can be applied to a so-called downmix, for example, in which the same signal or signal components of identical type were added to further original or progressively formed channels, wherein one or a plurality of levels may be known from one or a plurality of original or progressively formed signals.

Hereinafter, as part of the subject matter of the invention, such a correlation comparison of two signals Lᵢ′ and Rᵢ′ is proposed, for which respectively identical signal components x(t) and y(t) are determined which have for the short-time cross-correlation

$$r = \frac{1}{2 T} * {\int }_{- T}^{T} x ( t ) y ( t ) d t * \frac{1}{{x ( t )}_{eff} {y ( t )}_{eff}}$$

the degree of correlation +1. The proposed correlation comparison on the one hand represents a mathematically exact solution for time-invariant (steady-state) signals and has a specific residual behavior in the case of time-variant (non-steady-state) signals (wherein a residual represents the difference between the original, non-steady-state signal section and the Fourier transform thereof).

The possible obtaining of the corresponding residual is likewise presented as part of the subject matter of the invention.

Hereinafter, as part of the subject matter of the invention which makes use of the specific residual behavior, an approximate extraction method for residuals is proposed, if the residuals of the overall system are known.

Two channels Lᵢ′, Rᵢ′, 1≦i≦n, which have signal components Cᵢ* of identical type, are considered, wherein it holds true that:

Lᵢ′=Lᵢ*+Cᵢ*=lᵢ′(t)=lᵢ*(t)+cᵢ*(t)

Rᵢ′=Rᵢ*+Cᵢ*=rᵢ′(t)=rᵢ*(t)+cᵢ*(t)

The Fourier series are then determined in each case for the time-dependent signals lᵢ′(t) and rᵢ′(t). Accordingly, the following holds true for the synthesis, k=. . . , −1, 0, 1, . . .

$${l}_{i}^{′} ( t ) = {\sum }_{k = - ∞}^{∞} {x}_{k} {e}^{i k {ω}_{0} t}$$

$${r}_{i}^{′} ( t ) = {\sum }_{k = - ∞}^{∞} {y}_{k} {e}^{i k {ω}_{0} t}$$

and for the analysis

$${x}_{k} = \frac{1}{{T}_{0}} {\int }_{- {T}_{0} / 2}^{{T}_{0} / 2} {l}_{i}^{′} ( t ) {e}^{- i k {ω}_{0} t} d t$$

$${y}_{k} = \frac{1}{{T}_{0}} {\int }_{- {T}_{0} / 2}^{{T}_{0} / 2} {r}_{i}^{′} ( t ) {e}^{- i k {ω}_{0} t} d t$$

and in practice for the Discrete Fourier Transforms (DFT), from which the Fast Fourier Transforms (FFT) can be derived directly, wherein now k=0, . . . , N−1:

$${L}_{i}^{′} ( k ) = {\sum }_{m = 0}^{N - 1} {l}_{i}^{′} ( m ) {e}^{- i \frac{2 π}{N} mk}$$

$${R}_{i}^{′} ( k ) = {\sum }_{m = 0}^{N - 1} {r}_{i}^{′} ( m ) {e}^{- i \frac{2 π}{N} mk}$$

The real parts of Lᵢ, Rᵢ and Cᵢ can then be recovered for steady-state signals for all k=0, . . . , N−1 in accordance with the following rules:
1. Determine the signs of the real parts of Lᵢ′(k) and Rᵢ′(k).
2. If the signs are identical for k, determine
   the absolute values of the real parts of Lᵢ′(k) and Rᵢ′(k),
   the minima and maxima of these absolute values of the real parts of Lᵢ′(k) and Rᵢ′(k).
   Choose in each case as the real part for Cᵢ(k) the real part of Lᵢ′(k) or Rᵢ′(k) underlying said minimum.
   Subtract the real part of Cᵢ(k) from the real part of Lᵢ′(k) or Rᵢ′(k) underlying the maximum and, if the real part of Lᵢ′(k) underlies said maximum, choose the result of this subtraction as the real part
   for Lᵢ(k), otherwise, if the real part of Rᵢ′(k) underlies said maximum, choose the result of this subtraction as the real part for Rᵢ(k).
   Set the real part of Lᵢ(k) or Rᵢ(k) that has not been determined to be equal to zero.
3. If the signs of the real parts of Lᵢ′(k) and Rᵢ′(k) are not identical, set Cᵢ(k) to be equal to zero and set Lᵢ(k)=Lᵢ′(k) and Rᵢ(k)=Rᵢ′(k).

The imaginary parts of Lᵢ, Rᵢ and Cᵢ can be recovered for steady-state signals for all k=0, . . . , N−1 in accordance with the following rules:
1. Determine the signs of the imaginary parts of Lᵢ′(k) and
2.If the signs are identical for k, determine the absolute values of the imaginary parts of Lᵢ′(k) and Rᵢ′(k),
   the minima and maxima of these absolute values of the imaginary parts of Lᵢ′(k) and Rᵢ′(k).
   Choose in each case as the imaginary part for Cᵢ(k) the imaginary part of Lᵢ′(k) or Rᵢ′(k) underlying said minimum.
   Subtract the imaginary part of Cᵢ(k) from the imaginary
   part of Lᵢ′(k) or Rᵢ′(k) underlying the maximum and, if the imaginary part of Lᵢ′(k) underlies said maximum, choose the result of this subtraction as the
   imaginary part for Lᵢ(k), otherwise, if the imaginary part of Rᵢ′(k) underlies said maximum, choose the result of this subtraction as the imaginary part for Rᵢ(k).
   Set the imaginary part of Lᵢ(k) or Rᵢ(k) that has not been determined to be equal to zero.
3. If the signs of the imaginary parts of Lᵢ′(k) and Rᵢ′(k) are not identical, set Cᵢ(k) to be equal to zero and set Lᵢ(k)=Lᵢ′(k) and Rᵢ(k)=R_{i′(k).}

In order finally to obtain Lᵢ, Rᵢ and Cᵢ, for the synthesis for the time-dependent signals, k=. . . , −1, 0, 1, . . . ,

$${l}_{i} ( t ) = {\sum }_{k = - ∞}^{∞} {f}_{k} {e}^{i k {ω}_{0} t}$$

$${r}_{i} ( t ) = {\sum }_{k = - ∞}^{∞} {g}_{k} {e}^{i k {ω}_{0} t}$$

$${c}_{i} ( t ) = {\sum }_{k = - ∞}^{∞} {h}_{k} {e}^{i k {ω}_{0} t}$$

(or in practice for the analysis by means of Discrete Fourier Transforms (DFT), k=0, . . . , N−1,

$${L}_{i} ( k ) = {\sum }_{m = 0}^{N - 1} {l}_{i} ( m ) {e}^{- i \frac{2 π}{N} mk}$$

$${R}_{i} ( k ) = {\sum }_{m = 0}^{N - 1} {r}_{i} ( m ) {e}^{- i \frac{2 π}{N} mk}$$

$${C}_{i} ( k ) = {\sum }_{m = 0}^{N - 1} {c}_{i} ( m ) {e}^{- i \frac{2 π}{N} mk}$$

from which the Fast Fourier Transforms (FFT) can be derived directly) for the synthesis the coefficients fₖ, gₖ, hₖ are determined, k=. . . , −1, 0, 1, . . . , in accordance with the analysis

$${f}_{k} = \frac{1}{{T}_{0}} {\int }_{- {T}_{0} / 2}^{{T}_{0} / 2} {l}_{i} ( t ) {e}^{- i k {ω}_{0} t} d t$$

$${g}_{k} = \frac{1}{{T}_{0}} {\int }_{- {T}_{0} / 2}^{{T}_{0} / 2} {r}_{i} ( t ) {e}^{- i k {ω}_{0} t} d t$$

$${h}_{k} = \frac{1}{{T}_{0}} {\int }_{- {T}_{0} / 2}^{{T}_{0} / 2} {c}_{i} ( t ) {e}^{- i k {ω}_{0} t} d t$$

or for the synthesis in accordance with the Inverse Discrete Fourier Transform (IDFT), from which the Inverse Fast Fourier Transforms (IFFT) can be derived directly, k=0, . . . , N−1,

$${l}_{i} ( m ) = \frac{1}{N} {\sum }_{m = 0}^{N - 1} {L}_{i} ( k ) {e}^{i \frac{2 π}{N} mk}$$

$${r}_{i} ( m ) = \frac{1}{N} {\sum }_{m = 0}^{N - 1} {R}_{i} ( k ) {e}^{i \frac{2 π}{N} mk}$$

$${c}_{i} ( m ) = \frac{1}{N} {\sum }_{m = 0}^{N - 1} {C}_{i} ( k ) {e}^{i \frac{2 π}{N} mk}$$

Since a series of audio codecs for lossless or lossy compression of audio signals already make use of the Fourier Transform or FFT, it is possible, moreover, with low computational complexity, to integrate the above-described rules for obtaining the real parts or imaginary parts directly into such audio codecs, or to derive signals from such audio codecs which can be subjected to these rules for obtaining the real parts or imaginary parts.

The schematic sequence of such a correlation comparison is illustrated by way of example in FIG. 15:

For a respective channel of the time-dependent downmix signal Lᵢ(t), Rᵢ(t) firstly a Fast Fourier Transform (FFT) is performed, and the frequency-dependent complex-valued signal descriptions Lᵢ(k) and Rᵢ(k) thus result. In this way, the rules for obtaining the real parts and the imaginary parts of Lᵢ, Rᵢ and Cᵢ are then applied. Finally, a respective Inverse Fast Fourier Transform (IFFT) is applied to the resulting signal descriptions Lᵢ(k), Rᵢ(k) and Cᵢ(k). The time-dependent signals cᵢ(t), lᵢ(t) and rᵢ(t) result.

For non-steady-state signals, with this form of correlation comparison a residual Δ occurs which generally has the following behavior:

Lᵢ=Lᵢ*+Δ

Rᵢ=Rᵢ*+Δ

Cᵢ=Cᵢ*−2Δ

This residual is unimportant psychoacoustically, if what is involved is the pure reproduction of Lᵢ, Rᵢ and Cᵢ according to an Inverse Discrete Fourier-Transform (IDFT), from which the Inverse Fast Fourier Transform (IFFT) can be derived directly, within a normative listening situation (within the “Sweet Spot”), since the residual is extinguished. Outside the “Sweet Spot”, as occurs in listening situations in everyday life and in non-normative loudspeaker installations, distinctly audible artifacts can occur, however, which need to be avoided.

In particular, in the spatial coding of multichannel signals, if such extracted signals underlie this coding, particularly outside the normative listening situation (outside the “Sweet Spot”), colorations of the timbre and other demasking effects may arise.

Depending on the application, it is thus desirable to determine such residuals, this being done in an encoder, for example, and, if appropriate, in order to reduce the number of transmission channels overall, to approximate the latter as well as possible in order to minimize colorations of the timbre and other demasking effects in the further spatial coding or to eliminate them with regard to subjective perception.

The residual Δ itself can be obtained for instance in a frequency-dependent manner (the Fourier Transform for Lᵢ or Rᵢ or Cᵢ is already known, and it is thus only necessary to implement the Fourier Transform for Lᵢ* or Rᵢ* or Cᵢ* in the same way as described for Lᵢ or Rᵢ or Cᵢ) for each frequency k as follows (in the case of frequency-dependent calculation, it is necessary, if appropriate, to implement for Δ(k) afterward an Inverse Discrete Fourier Transform (IDFT), from which the Inverse Fast Fourier Transform (IFFT) can be derived directly, as described for Lᵢ or Rᵢ or Cᵢ):

Δ(k)=Lᵢ(k)−Lᵢ*(k)

or

Δ(k)=Rᵢ(k)−Rᵢ*(k)

or

Δ(k)=½*(k)−C*ᵢ(k))

This means that in order to obtain a residual-free signal by means of correlation comparison from two channels Lᵢ′ and Rᵢ′, 1≦i≦n, which have signal components Cᵢ* of identical type, the associated residual Δ must also be known, which is determined within the encoder, for instance, which constitutes a great restriction in audio coding, for example, since, for instance, the number of channels to be transmitted to the decoder in absolute terms cannot be reduced to the effect that such a residual must also be added to each correlation comparison. Alternatively, the residuals can also be determined in a time-dependent manner if the common signal Cᵢ(t) determined by correlation comparison or the first individual signal Lᵢ(t) determined by correlation comparison or the second individual signal Rᵢ(t) determined by correlation comparison is present in a time-dependent manner.

In principle, such residual-free signals can be obtained by simple subtraction or addition both in a frequency-dependent manner and in a time-dependent manner:

Lᵢ*=Lᵢ−Δ

Rᵢ*=Rᵢ−Δ

Cᵢ′=Cᵢ+2Δ

However, it can be shown that for example for respectively adjacent channels Lᵢ, Cᵢ, Rᵢ, Cᵢ₂ and Bᵢ where

Lᵢ′=Lᵢ*+Cᵢ₁′

Rᵢ₁′=Rᵢ*+Cᵢ₁*+Cᵢ₂*

Rᵢ₂′=Rᵢ*+Cᵢ₁*+Cᵢ₂*

Bᵢ′=Bᵢ*+Cᵢ₂*

the residual Δ₂ that results from the correlation comparison between Rᵢ₂′ and Bᵢ′ cannot be derived in linear form from a residual Δ₁ that results from the correlation comparison between Lᵢ′ and Rᵢ₁′.

An ideal approximate determination, which additionally represents the drastic reduction of the number of residuals to be transmitted, consists in the following consideration:

If n residuals Δ₁, Δ₂, Δ₃, Δ₄, . . . , Δₙ were determined, and the following hold true for the differences

$${Δ}_{2} - {Δ}_{1} = {η}_{3} - {η}_{n}$$

$${Δ}_{3} - {Δ}_{2} = {η}_{4} - {η}_{1}$$

$${Δ}_{4} - {Δ}_{3} = {η}_{5} - {η}_{2}$$

$$…$$

$${Δ}_{n} - {Δ}_{n - 1} = {η}_{1} - {η}_{n - 2}$$

$${Δ}_{1} - {Δ}_{n} = {η}_{2} - {η}_{n - 1}$$

then it is possible to derive the relationships

$${Δ}_{1} = {η}_{2} - {η}_{n - 1} + {Δ}_{n}$$

$${Δ}_{2} - {Δ}_{1} = {Δ}_{2} - ( {η}_{2} - {η}_{n - 1} + {Δ}_{n} ) = {η}_{3} - {η}_{n}$$

$$or$$

$${Δ}_{2} = {η}_{3} - {η}_{n} + ( {η}_{2} - {η}_{n - 1} + {Δ}_{n} )$$

$${Δ}_{3} - {Δ}_{2} = {Δ}_{3} - ( {η}_{3} - {η}_{n} + ( {η}_{2} - {η}_{n - 1} + {Δ}_{n} ) ) = {η}_{4} - {η}_{1}$$

$$or$$

$${Δ}_{3} = {η}_{4} - {η}_{1} + ( {η}_{3} - {η}_{n} + ( {η}_{2} - {η}_{n - 1} + {Δ}_{n} ) )$$

$${Δ}_{4} - {Δ}_{3} = {Δ}_{4} - ( {η}_{4} - {η}_{1} + ( {η}_{3} - {η}_{n} + ( {η}_{2} - {η}_{n - 1} + {Δ}_{n} ) ) ) = {η}_{5} - {η}_{2}$$

$$or$$

$${Δ}_{4} = {η}_{5} - {η}_{2} + ( {η}_{4} - {η}_{1} + ( {η}_{3} - {η}_{n} + ( {η}_{2} - {η}_{n - 1} + {Δ}_{n} ) ) ) . \\ …$$

$${Δ}_{1} - {Δ}_{n} = ( {η}_{2} - {η}_{n - 1} + {Δ}_{n} ) - {Δ}_{n} = {η}_{2} - {η}_{n - 1}$$

$$or$$

$${Δ}_{1} = ( {η}_{2} - {η}_{n - 1} + {Δ}_{n} )$$

Consequently, for example (η₂−ηₙ₋₁+Δₙ) is a term contained in all the residuals. The same consideration can be applied to each Δᵢ, i=1, . . . , n. Since n remains small in practice, it follows therefrom that with each term thus determined each residual can be approximated with a high accuracy.

If the following are then set

$${Δ}_{2} - {Δ}_{1} = {η}_{3} - {η}_{n} = {a}_{1}$$

$${Δ}_{3} - {Δ}_{2} = {η}_{4} - {η}_{1} = {a}_{2}$$

$${Δ}_{4} - {Δ}_{3} = {η}_{5} - {η}_{2} = {a}_{3}$$

$${Δ}_{5} - {Δ}_{4} = {η}_{6} - {η}_{3} = {a}_{4}$$

$${Δ}_{6} - {Δ}_{5} = {η}_{7} - {η}_{4} = {a}_{5}$$

$${Δ}_{7} - {Δ}_{6} = {η}_{8} - {η}_{5} = {a}_{6}$$

$${Δ}_{8} - {Δ}_{7} = {η}_{9} - {η}_{6} = {a}_{7}$$

$${Δ}_{9} - {Δ}_{8} = {η}_{10} - {η}_{7} = {a}_{8}$$

$${Δ}_{10} - {Δ}_{9} = {η}_{11} - {η}_{8} = {a}_{9}$$

$$…$$

$${Δ}_{1} - {Δ}_{n} = {η}_{2} - {η}_{n - 1} = {a}_{n}$$

$$the result is that$$

$${η}_{3} = {η}_{n} + {a}_{1}$$

$${η}_{6} = {η}_{n} + {a}_{1} + {a}_{4}$$

$${η}_{9} = {η}_{n} + {a}_{1} + {a}_{4} + {a}_{7}$$

$$…$$

$$or$$

$${η}_{4} = {η}_{1} + {a}_{2}$$

$${η}_{7} = {η}_{1} + {a}_{2} + {a}_{5}$$

$${η}_{10} = {η}_{1} + {a}_{2} + {a}_{5} + {a}_{8}$$

$$…$$

$$or$$

$${η}_{5} = {η}_{2} + {a}_{3}$$

$${η}_{8} = {η}_{2} + {a}_{3} + {a}_{6}$$

$${η}_{11} = {η}_{2} + {a}_{3} + {a}_{6} + {a}_{9}$$

$$…$$

From the relationships

ηₙ=ηₙ+a₁+a₄+a₇+ . . . +aₙ₋₂ or

ηₙ₋₁=ηₙ₋₁+aₙ+a₃+a₆+ . . . +aₙ₋₃ or

ηₙ₋₂=ηₙ₋₂+aₙ₋₁+a₂+a₅+ . . . +aₙ₋₄

it is then possible to derive the “difference rule for residuals”

(a₁+a₄+a₇+ . . . +a_{n 2})+(aₙ+a₃+a₆+ . . . +aₙ₋₃)+(aₙ₋₁+a₂+a₅+ . . . +aₙ₋₄)=0

which means that a₁, a₂, a₃, . . . , aₙ have an ideal residual behavior psychoacoustically within a normative listening situation (within the “Sweet Spot”) by virtue of their mutually canceling one another out.

From the above “difference rule”, it is possible directly to derive the following “addition theorem for residuals”, namely

Δ₁+Δ₂+Δ₃+ . . . +Δₙ=n*(η₂−ηₙ₋₁+Δₙ)

which means that the average value of all the residuals is contained simultaneously therein and can also be calculated without difficulty, for example within an encoder.

If the residual correction, instead of being performed with the aid of the residuals Δ₁, Δ₂, Δ₃, . . . , Δₙ, is then performed with the aid of the average value thereof, it is possible not just to minimize colorations of the timbre and other demasking effects in a targeted manner, but at the same time to transmit a drastically reduced number of channels, for example from an audio encoder to an audio decoder.

It is thus now possible in accordance with FIG. 2, in which the circumscribed triangle denotes with the corners thereof the number of downmix channels and the inscribed, dashed triangle denotes the number of channels additionally extracted by means of correlation comparison (which channels are subsequently subtracted from the associated downmix channels in order approximately to obtain all the original channels of the circumscribed triangle), upon transmission of the average value of all the residuals, to extract from at least three channels a maximum of six channels that have significantly smaller artifacts or colorations of the timbre and other demasking effects. In other words, the vertices of the circumscribed triangle describe the three downmix channels of a multichannel signal having six channels. A vertex of the inscribed triangle describes a channel of the multichannel signal that is admixed with the two adjacent downmix channels. Such a further channel lying between two downmix channels can be obtained by means of a correlation comparison between the two adjacent downmix channels (the vertices of the circumscribed triangle) by virtue of the fact that this signal contained in both downmix channels is extracted, and also in each case the sum of the two original, outer corner signals before the downmix with their adjacent signal that lies in the centre of that side of the triangle which is closest to the corner signal respectively considered (note: not on that side on which the first correlation comparison was carried out!). If a correlation comparison is then also carried out for the two downmix channels of this newly considered side, the signal contained in both downmix channels is again extracted. Said signal can be subtracted from the closest sum of the first correlation comparison, and then yields the original corner signal. If this is done for all three adjacent pairs of downmix channels, the six channels of the multichannel signal are obtained again. Since in addition to the downmix signals, if not steady-state, then for the exact calculation of the six multichannel signals three residuals would also have to be transmitted in addition to the three downmix channels, the volume of data to be transmitted would again be equal to the transmission of the multichannel signal. Therefore, the average value of all three residuals is then transmitted and the six channels of the multichannel signal obtained from the correlation comparison are corrected on the basis of this averaged residual.

Likewise, it is now possible in accordance with FIG. 3, in which the circumscribed square denotes with the corners thereof the number of downmix channels and the inscribed, dashed square denotes the number of channels additionally extracted by means of correlation comparison (which channels are subsequently subtracted from the associated downmix channels in order approximately to obtain all the original channels of the circumscribed square), upon transmission of the average value of all residuals, to extract from at least four downmix channels a maximum of eight channels that have significantly smaller artifacts or colorations of the timbre and other demasking effects.

It is thus now possible in accordance with FIG. 4, in which the circumscribed pentagon denotes with the corners thereof the number of downmix channels and the inscribed, dashed pentagon denotes the number of channels additionally extracted by means of correlation comparison (which channels are subsequently subtracted from the associated downmix channels in order approximately to obtain all the original channels of the circumscribed pentagon), upon transmission of the average value of all residuals, to extract from at least five channels a maximum of ten channels that have significantly smaller artifacts or colorations of the timbre and other demasking effects.

FIGS. 2 to 4 have purely combinational significance and should not be confused with concrete loudspeaker positions.

This scheme can be extended toward infinity, although the calculated average value of all the residuals, on account of considerations above, increasingly results in artifacts or colorations of the timbre and other demasking effects.

Further channels can be calculated approximately in all cases with an inverse coding of existent or progressively derived channels or else other further spatial coding methods known from the prior art:

Hereinafter, “inverse coding” is understood to mean a technical sequence which makes use of one or more methods or one or more devices from the claims of the applications EP1850629 or WO2009138205 or WO2011009649 or WO2011009650 or WO2012016992 or WO2012032178, wherein the documents just mentioned are hereby introduced as reference. In particular, the linear inverse coding is described in said documents. FIG. 9 shows the example of such a linear inverse coding.

The downmix channels and/or residuals that are intended to serve for maximally efficient storage and transmission of audio data, for example between an encoder and a decoder, can additionally be compressed and decompressed with a corresponding lossless or lossy Base Audio Codec known from the prior art (examples of such a Base Audio Codec are Opus or the MPEG standards MP3, AAC, HE-AAC, HE-AAC v2 and USAC), wherein the Base Audio Codec respectively used can additionally be optimized with regard to the overall underlying spatial coding method (“tuning”).

In particular, since a series of audio codecs for lossless or lossy compression of audio signals already make use of the Fourier transform or Fast Fourier Transform (FFT), it is possible, moreover, with low computational complexity, to integrate the above-described rules for obtaining the real parts or imaginary parts of signals directly into such audio codecs, or to derive signals from such audio codecs which can be subjected to these rules for obtaining the real parts or imaginary parts. The computational complexity required overall can thus be significantly reduced.

### DESCRIPTION OF THE DRAWINGS

Various embodiments of the present invention are described by way of example below, wherein reference is made to the following drawings:

FIG. 1 shows the eight possible cases of an unexpectedly convenient algorithm for the correlation comparison of two signals on the basis of a Fourier transform, wherein those signal components which have the degree of correlation +1 for the short-time cross-correlation are extracted exactly for steady-state signals. For non-steady-state signals, subsequently a residual correction is likewise possible in accordance with the disclosure of the invention exactly or else with the aid of the average value of all the residuals.

FIG. 2 illustrates geometrically the combinational application of such a correlation comparison to a corresponding downmix with three channels, which is illustrated by the circumscribed triangle.

FIG. 3 illustrates geometrically the combinational application of such a correlation comparison to a corresponding downmix with four channels, which is illustrated by the circumscribed square.

FIG. 4 illustrates geometrically the combinational application of such a correlation comparison to a corresponding downmix with five channels, which is illustrated by the circumscribed pentagon.

FIG. 5 shows a 5.1 surround arrangement according to ITU-R BS.775-1.

FIG. 6 shows a coding according to the invention of multichannel signals with the aid of correlation comparison and possible residual correction or additional spatial coding.

FIG. 7 shows an NHK-22.2 arrangement.

FIG. 8 shows the application from FIG. 6 to an NHK-22.2 middle layer signal with simultaneous application of two inverse codings for FL, FLc and FR, FRc.

FIG. 9 shows the example of a linear inverse coding in accordance with the unpublished application CH02300/12.

FIG. 10 shows the application from FIG. 6 to an NHK-22.2 top layer signal with simultaneous correlation comparison for obtaining the TpC. Said correlation comparison takes place in the psychoacoustically noncritical frontal principal axis above the head, in which an exact localization remains difficult.

FIG. 11 shows the application from FIG. 6 to an NHK-22.2 top layer signal with simultaneous panning of the sum of TpC and TpFC. Said panning takes place in the psychoacoustically noncritical frontal principal axis above the head, in which an exact localization remains difficult. As an alternative or in addition to the panning, an inverse coding can also be performed.

FIG. 12 shows an encoder module on the basis of the subject matter of the invention, which calculates both a downmix and the residual of the associated correlation comparison, this in accordance with the rules for obtaining the real and imaginary parts of signals, see the disclosure of the invention. A Fourier Transform (FFT) was previously performed on all the output signals.

FIG. 13 shows an encoder for an NHK-22.2 top layer signal on the basis of the subject matter of the invention, which calculates both the entire downmix and the average value of all the residuals calculated by the encoder modules.

FIG. 14 shows a decoder which approximately calculates the original input signals of the encoder with the aid of the entire downmix and the transmitted average value of all the residuals calculated by the encoder modules by means of correlation comparison, this in accordance with the rules for obtaining the real and imaginary parts of signals, see the disclosure of the invention, and by means of summation and difference formation. Finally, the Inverse Fast Fourier Transforms (IFFT) are determined.

FIG. 15 shows the principle of the illustrated correlation comparison, this in accordance with the rules for obtaining the real and imaginary parts of signals, see the disclosure of the invention. A Fast Fourier Transform (FFT) is performed before said correlation comparison, and an Inverse Fast Fourier Transform (IFFT) is performed after said correlation comparison.

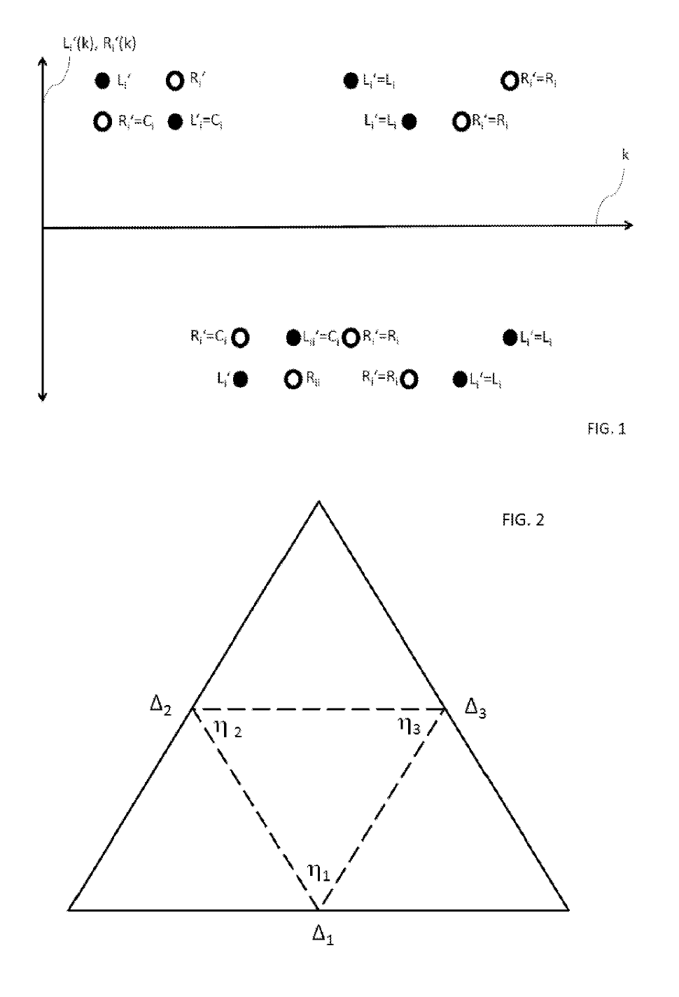

### DETAILED DESCRIPTION

Application of the Subject Matter of the Invention to a 5.1 Surround Signal:

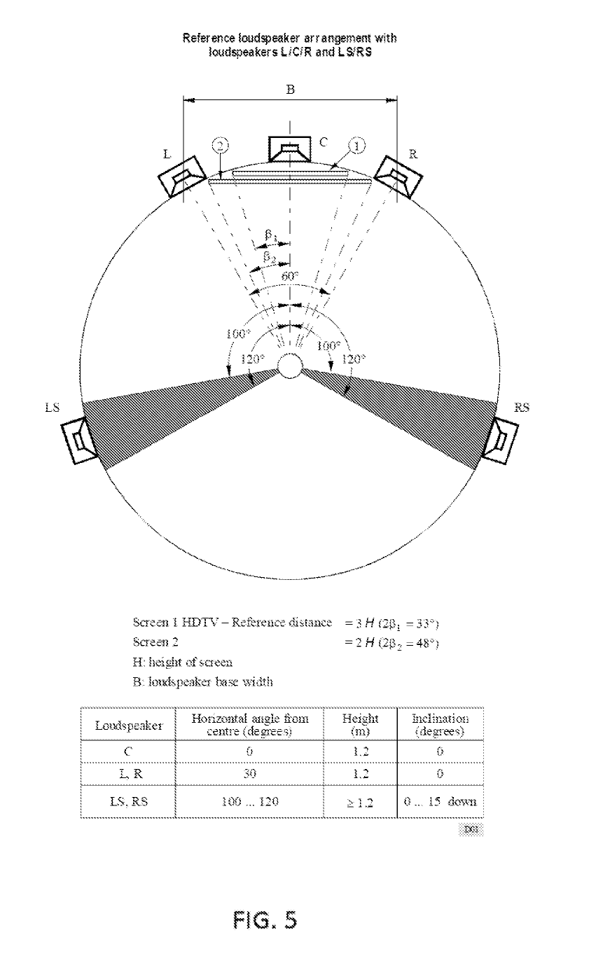

A first, simple example of an application of the subject matter of the invention to a 5.1 surround signal in accordance with ITU-R BS.775-1, see FIG. 5, this with additional application of an inverse coding, constitutes for the channels L*, R*, C*, LS*, RS* the summation (the “downmix”)

L′=(L*+1/√2*LS*)+½*C

R′=(R*+1/√2*RS*)+½*C

L′ and R′ can be compressed and subsequently decompressed with the aid of a Base Audio Codec, that can be specifically adapted for this purpose (“tuning”), this for the purpose of efficient storage or transmission, see FIG. 6 (wherein an additional spatial encoding and decoding with the aid of the so-called inverse coding also takes place in the present example).

In the encoder, firstly the left signals LS* and L* are combined to form a common left signal (L*+1/√2*LS*), and the right signals RS* and R* are combined to form a common right signal (R*+1/√√2*RS*). For determining the parameters which lead psychoacoustically to the separation of the signals (LS* and L* and respectively RS* and R*) from the common signal ((L*+1/√2*LS*), (R*+1/√2*RS*)), a method of inverse coding is used such as is disclosed in one of the patent applications WO2009138205, WO2011009649, WO2011009650, WO2012016992 or WO2012032178. The disclosure of said applications is incorporated here for the determination of the parameters that are necessary for the psychoacoustic separation of the signals (LS* and L* or RS* and R*) from the common signal ((L*+1/√2*LS*), (R*+1/√2*RS*)). By correlation comparison in accordance with the rules for obtaining the real and imaginary parts of signals, see the disclosure of the invention, from L′ and R′ it is then possible to extract a signal ½*C (which is subsequently multiplied by the factor 2) and also two signals L and R. In the encoder, by means of the method according to the invention of correlation comparison between L′ and R′ an estimation of the signals (L*+1/√2*LS*) or (R*+1/√2*RS*) or C* is determined, and the difference with the actual signal is formed in order to determine the residual Δ. The encoder then outputs L′, R′, A and the parameters for the separation of the common left signal into the two left signals, and the parameters for the separation of the common right signal into the two right signals.

The correlation comparison can make use of a Fourier transform that is already performed in the base audio coder, by which means the computational complexity required overall can be significantly decreased.

In the decoder, an estimation of the signals (L*+1/√2*LS*), (R*+1/√2*RS*) and C* is determined on the basis of the correlation comparison according to the invention from L′ and R′.

With the aid of the optionally transmitted residual Δ for this correlation comparison, for instance from an encoder to a decoder, it is then possible to reconstruct the original signals C*, (L*+1/√2*LS*) and (R*+1/√2*RS*) from their estimations C, (L+1/√2*LS) and (R+1/√2*RS) in accordance with the following formulae:

C*=C+2Δ

(L*+1/√2*LS*)=(L+1/√2*LS)−Δ

(R+1/√2*RS*)=(R+1/√2*RS)−Δ

On account of the small number of channels, however, such a residual determination would not result in an actual compression, but rather serves here to illustrate the fundamental residual behavior that is associated with such a correlation comparison and can be correspondingly corrected. In this case, the decoded common left signal (L*+1/√2*LS*) corresponds to the original channel combination (L*+1/√2*LS*) of the multichannel signal. If, in a multichannel signal having more channels, an averaged residual additionally based on other channels is used for the correction, the decoded common left signal (L*+1/√2*LS*) is only an estimation (analogously for the common right signal).

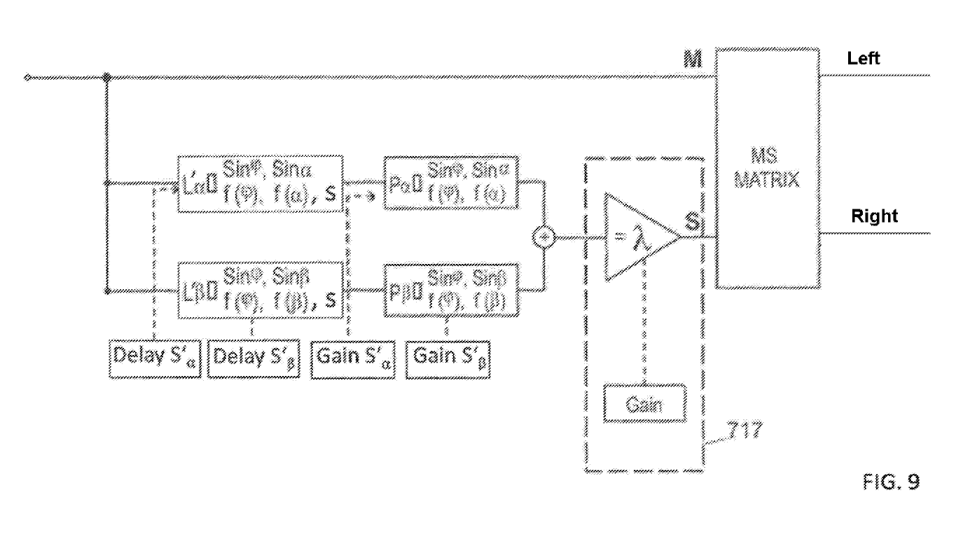

On the basis of the parameters transmitted for the separation, two left channels L*and LS*are then calculated approximately for the common left signal (L*+1/√2*LS*) obtained by correlation comparison and possibly by residual correction, and two right channels R*and RS* are then calculated for the common right signal (R*+1/√2*RS*) obtained by correlation comparison and possibly by residual correction. This can be done with the aid of a linear coding such as is illustrated e.g. in FIG. 9. In this case, the parameters received by the encoder φ (angle between sound source and microphone principal axis), α (specific left opening angle), β (specific right opening angle), f (directional characteristic of the monosignal to be stereophonized), λ (amplifier for altering the degree of correlation or damping for altering the degree of correlation) or ρ (damping for altering the degree of correlation) and s (time parameter) (or parameters derived from these parameters) are used in the decoder to obtain psychoacoustically optimum delays and gains of the input signal and thus to split an input signal into two adjacent channels.

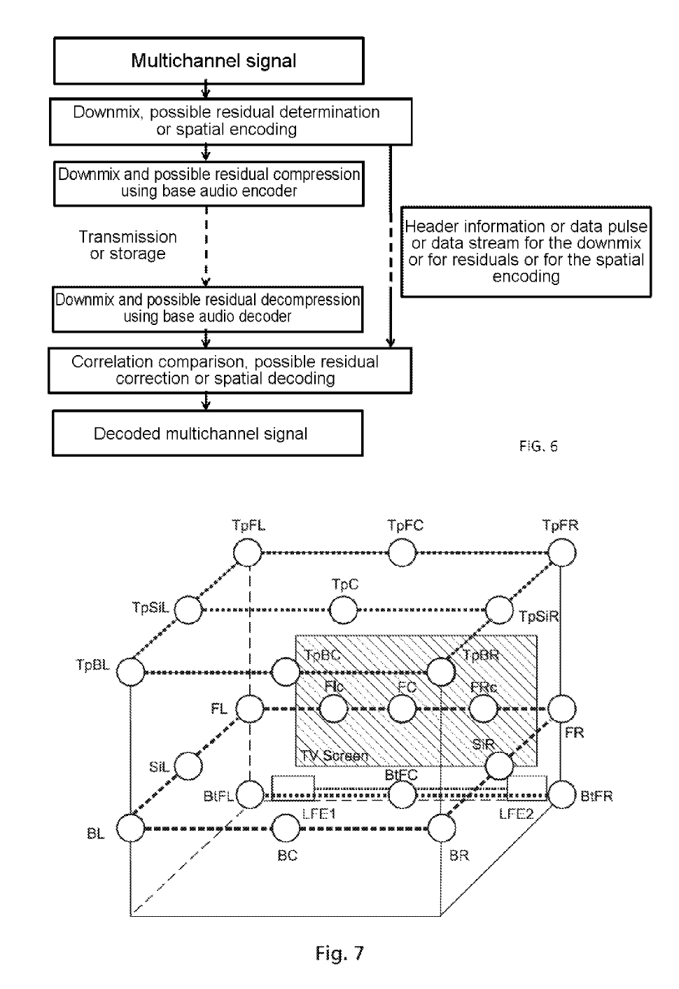

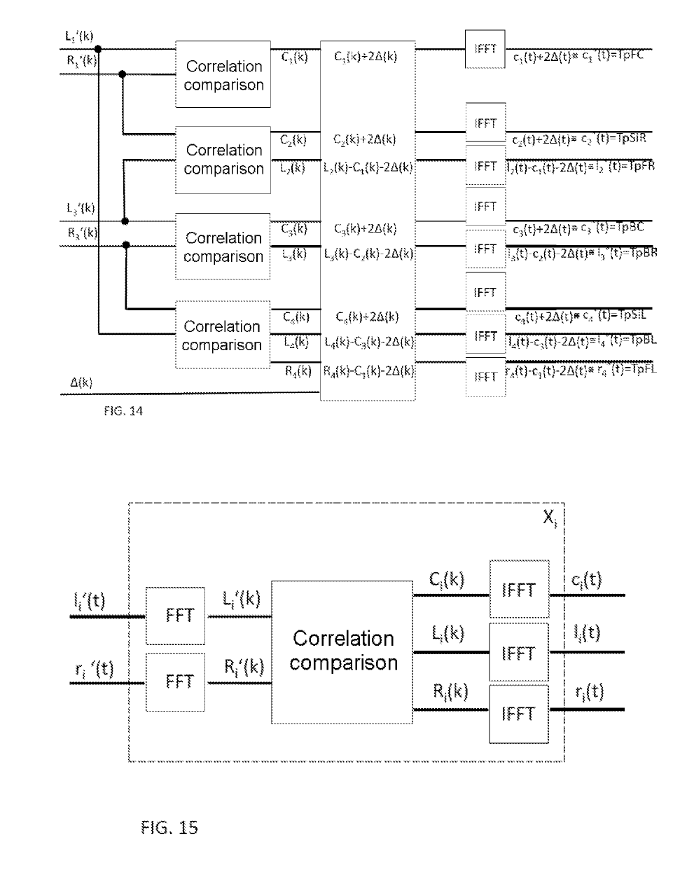

Application of the Subject Matter of the Invention to an NHK-22.2 Middle Layer Signal (See FIGS. 7, 8 and 15):

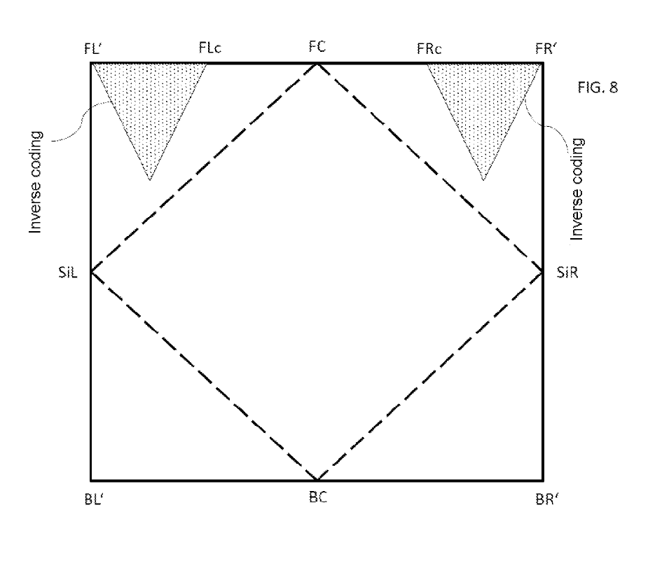

A second, complex example of an application of the subject matter of the invention, here in accordance with FIG. 8, to an NHK-22.2 middle layer signal as multichannel signal, see FIG. 7, constitutes for the channels FL, FR, FC, BL, BR, FLc, FRc, BC, SiL and SiR the summation (the channels of the downmix signal)

FL′=FL+1/√2*FLc+0.5*FC+0.5*SiL

FR′=FR+1/√/2*FRc+0.5*FC+0.5*SiR

BL′=BL+0.5*SiL+0.5*BC

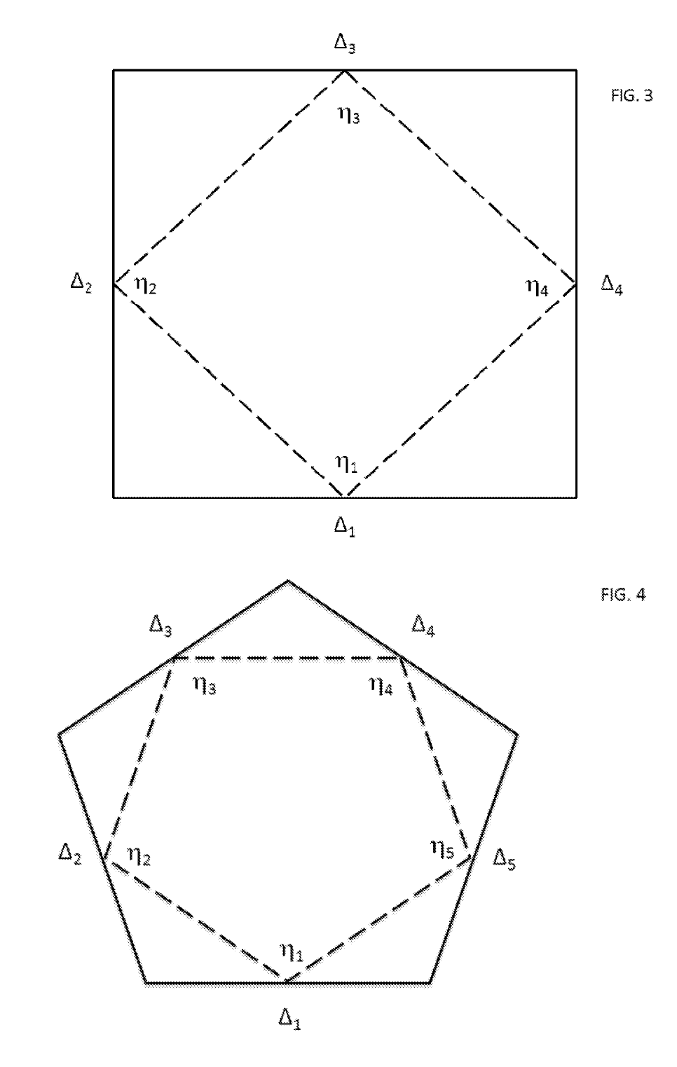

BR′=BR+0.5*SiR+0.5*BC

wherein FL′, FR′, BL′, BR′ correspond to the vertices of the circumscribed square from FIG. 3 in accordance with FIG. 8.

The channels FL and FLc are combined in the encoder before the correlation comparison, carried out for calculating the residuals, to form a common front left channel, and the parameters required for the separation are determined. The channels RL and RLc are combined in the encoder before the correlation comparison, carried out for calculating the residuals, to form a common front right channel, and the parameters required for the separation are determined. This is carried out e.g. as described in association with the combination of the channels LS*and L* in the 5.1 system. Correspondingly, in the decoder on the basis of the channels of the downmix signal FL′, FR′, BL′, BR′ with the correlation comparison and possibly a correction by the averaged residual Δ, the channels (FL+1/√2*FLc), (FR+1/√2*FRc), FC, BL, BR, BC, SiL and SiR of the multichannel signal are determined. Afterward, analogously to the channels L*, LS*, R*, RS*of the 5.1 system, the channels FL, FR, FLc, FRc are determined from the channels (FL+1/√2*FLc), (FR+1/√2*FRc). FL′, FR′, BL′, BR′ and also, if appropriate, the average value Δ of all the residuals Δ₁, Δ₂, Δ₃, Δ₄ can be compressed and subsequently decompressed with the aid of a base audio codec but can be specifically adapted for this purpose (“tuning”), this for the purpose of efficient storage or transmission, for example between an encoder and decoder, see FIG. 6 (wherein an additional spatial encoding and decoding with the aid of the inverse coding between the channels FL and FLc and respectively between the channels RL and RLc also takes place in the present example).

Likewise, the system described below can make use of a Fourier transform already performed in the base audio coder, by which means the computational complexity required overall can be significantly decreased.

By correlation comparison of FL′ and FR′ in accordance with the rules for obtaining the real and imaginary parts of signals, see the disclosure of the invention, a signal 0.5*(FC−2*Δ₁) is then extracted (which is subsequently multiplied by the factor 2) and two signals (FL+1/√2*FLc+0.5*SiL)+Δ₁ and (FR+1/√2*FRc+0.5*SiR)+Δ₁ are extracted. In this respect, see FIG. 8.

By correlation comparison of FR′ and BR′ in accordance with the rules for obtaining the real and imaginary parts of signals, see the disclosure of the invention, a signal 0.5*(SiR−2*Δ₂) is then extracted (which is subsequently multiplied by the factor 2) and two signals (FR+1/√2*FRc+0.5*FC)+Δ₂ and (BR+0.5*BC)+Δ₂ are extracted. In this respect, see FIG. 8.

By correlation comparison of BR′ and BL′ in accordance with the rules for obtaining the real and imaginary parts of signals, see the disclosure of the invention, a signal 0.5*(BC−2*Δ₃) is then extracted (which is subsequently multiplied by the factor 2) and two signals (BR+0.5*SiR)+Δ₃ and (BL+0.5*SiL)+Δ₃ are extracted. In this respect, see FIG. 8.

By correlation comparison of FL′ and BL′ in accordance with the rules for obtaining the real and imaginary parts of signals, see the disclosure of the invention, a signal 0.5*(SiL−2*Δ₄) is then extracted (which is subsequently multiplied by the factor 2) and two signals (FL+1/√2*FLc+0.5*FC)+Δ₄ and (BL+0.5*BC)+Δ₄ are extracted. In this respect, see FIG. 8.

With the signals 0.5*(FC−2*Δ₁), 0.5*(SiR−2*Δ₂), 0.5*(BC−2*Δ₃), 0.5*(SiL−2*Δ₄) thus extracted, it is then possible, if the residuals Δ₁, Δ₂, Δ₃, Δ₄ are not known, approximately to calculate all the other signals FL+1/√2*FLc, FR+1/√2*FRc, BR, BL:

FL+1/√2*FLc≅(FL+1/√2*FLc+0.5*SiL)+Δ₁−0.5*(SiL−2*Δ₄)≅(FL+1/√2*FLc+0.5*FC)+Δ₄−0.5*(FC−2*Δ₁)

FR+1/√2*FRc≅(FR+1/√2*FRc+0.5*SiR)+Δ₁−0.5*(SiR−2*Δ₂)≅(FR+1/√2*FRc+0.5*FC)+Δ₂−0.5*(FC−2*Δ₁)

BR≅(BR+0.5*BC)+Δ₂−0.5*(BC−2*Δ₃)≅(BR+0.5*SiR)+Δ₃−0.5*(SiR−2*Δ₂)

BL≅(BL+0.5*BC)+Δ₄−0.5*(BC−2*Δ₃)≅(BL+0.5*SiL)+Δ₃−0.5*(SiL−2*Δ₄)

It is evident from the doubled solution paths that the correlation comparison need not necessarily be carried out for all three possible output signals, see also FIG. 14, but rather can also contain fewer output signals. A myriad of different combination possibilities that can be derived from the above equations without difficulty emerge here.

Moreover, the same observations also apply to systems with residual corrections.

If the residuals Δ₁, Δ₂, Δ₃, Δ₄ are known, the following residual corrections designated in bold arise (wherein in the case of such a system, no compression can be achieved, however, since ultimately at least one such residual must be assigned to each correlation comparison):

FL+1/√2*FLc=(FL+1/√2*FLc+0.5*SiL)+Δ₂−0.5*(SiL−2*Δ₄)−Δ₁−Δ₄=(FL+1/√2*FLc+0.5*FC)+Δ₄−0.5*(FC−2*Δ₁)−Δ₄−Δ₁

FR+1/√2*FRc=(FR+1/√2*FRc+0.5*SiR)+Δ₂−0.5*(SiR−2*Δ₂)−Δ₁−Δ₂=(FL+1/√2*FLc+0.5*FC)+Δ₂−0.5*(FC−2*Δ₁)−Δ₂−Δ₁

BR=(BR+0.5*BC)+Δ₂−0.5*(B31 2*Δ₃)−Δ₂−Δ₃=(BR+0.5*SiR)+Δ₃−0.5*(SiR−2*Δ₂)−Δ₃−Δ₂

BL=(BL+0.5*BC)+Δ₄−0.5*(BC−2*Δ₃)−Δ₄−Δ₃=(BL+0.5*SiL)+Δ₃−0.5*(SiL−2*Δ₄)−Δ₃−Δ₄

If the residual corrections are then not performed with the aid of the residuals Δ₁, Δ₂, Δ₃, Δ₄, but rather with the aid of the average value Δ of all the residuals, the residual corrections designated in bold should then be replaced by the expression −2Δ. Compared with signals without residual correction, this results in significantly decreased artifacts or colorations of the timbre and other demasking effects, without all the residuals Δ₁, Δ₂, Δ₃, Δ₄, having to be transmitted, for example from an encoder to a decoder. A drastic reduction of the bandwidth thus results.

If other spatial encodings and decodings are intended to be applied, such as, for example, the so-called inverse coding in accordance with the present applicant's unpublished application CH02300/12, see FIG. 9, these can be directly integrated into the above considerations in accordance with FIG. 6.

By way of example, FL and FLc and respectively FR and FRc can advantageously likewise be obtained approximately by in each case such an inverse coding of the signals obtained absolutely or approximately for (FL+1/√2*FLc) and respectively for (FR+1/√2*FRc):

In this regard, for instance, the left output signal for FL of an arrangement in accordance with FIG. 9 is amplified with the factor 1 (60001), but the right output signal for FLc of such an arrangement is amplified with the factor 1/√2 (60002). In the same way, for instance, the right output signal for FR of an arrangement in accordance with FIG. 9 is amplified with the factor 1 (60002), but the left output signal for FRc of such an arrangement is amplified with the factor 1/√2 (60001).

An NHK-22.2 middle layer signal can thus be reduced very significantly with regard to data to be stored or to be transmitted, for example between an encoder and a decoder, in the sense of FIG. 6.

Application of the Subject Matter of the Invention to an NHK-22.2 Top Layer Signal Without TpC (see FIGS. 7 and 10 to 15):

The principle of action just described for an NHK-22.2 middle layer signal can be applied to an NHK-22.2 top layer signal without difficulty, if the following equations are implemented in the above example:

TpFL=FL+1/√2*FLc

TpFR=FR+1/√2*FRc

TpFC=FC

TpSiR=SiR

TpBR=BR

TpBC=BC

TpBL=BL

TpSiL=SiL

An additional spatial encoding and decoding for TpFL and TpFR is accordingly obviated.

However, the TpC, which plays a significant part for example in the case of NHK-22.2 top layer signals, is disregarded in such an application.

Application of the subject matter of the invention to an NHK-22.2 top layer signal with TpC (see FIGS. 7 and 10 to 15):

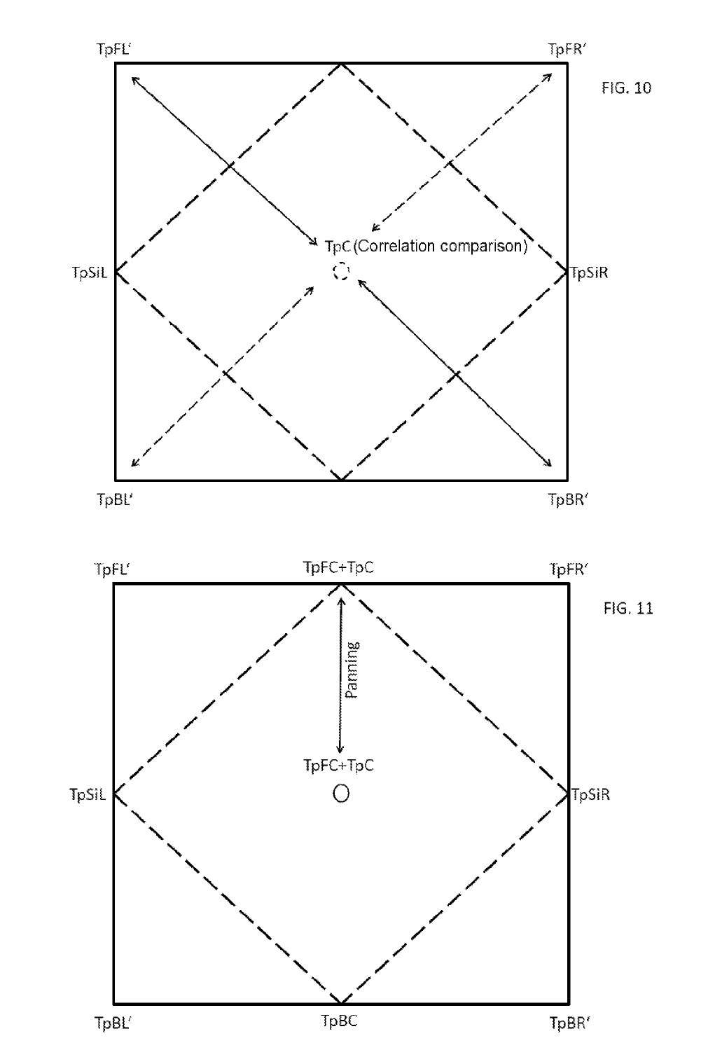

A fourth, complex example of an application of the subject matter of the invention, here in accordance with FIGS. 10 and 11, to an NHK-22.2 top layer signal, see FIG. 7, constitutes for the channels TpFL, TpFR, TpFC, TpC, TpBL, TpBR, TpSiL, TpSiR, TpBC the summation (the “downmix”)

TpFL′=TpFL+0.5*TpFC+0.5*TpSiL+0.5*TpC

TpFR′=TpFR+0.5*TpFC+0.5*TpSiR

TpBL′=TpBL+0.5*TpBC+0.5*TpSiL

TpBR′=TpBR+0.5*TpBC+0.5*TpSiR+0.5*TpC

and

TpFL′=TpFL+0.5*TpFC+0.5*TpSiL

TpFR′=TpFR+0.5*TpFC+0.5*TpSiR+0.5*TpC

TpBL′=TpBL+0.5*TpBC+0.5*TpSiL+0.5*TpC

TpBR′=TpBR+0.5*TpBC+0.5*TpSiR

wherein TpFL′, TpFR′, TpBL′, TpBR′ again correspond to the vertices of the circumscribed square from FIG. 10 in accordance with FIG. 3. It is then possible to carry out, for each side of the square, a correlation comparison in accordance with the rules for obtaining the real and imaginary parts of signals, see the disclosure of the invention, in the manner described for the previous NHK-22.2 arrangements, and the same signals as described above accordingly arise with the exception of a new

TpFL+0.5*TpC≅(TpFL+0.5*TpC+0.5*TpSiL)+Δ₁−0.5*(TpSiL−2*Δ₄)≅(TpFL+0.5*TpC+0.5*TpFC)+Δ₄−0.5*(TpFC−2*Δ₁)

and

TpBR+0.5*TpC≅(TpBR+0.5*TpC+0.5*TpBC)+Δ₂−0.5*(TpBC−2*Δ₃)≅(TpBR+0.5*TpC+0.5*TpSiR)+Δ₃−0.5*(TpSiR−2*Δ₂)

or

TpFR+0.5*TpC≅(TpFR+0.5*TpC+0.5*TpSiR)+Δ₁−0.5*(TpSiR−2*Δ₂)≅(TpFR+0.5*TpC+0.5*TpFC)+Δ₂−0.5*(TpFC−2*Δ₁)

and

TpBL+0.5*TpC≅(TpBL+0.5*TpC+0.5*TpBC)+Δ₄−0.5*(TpBC−2*Δ₃)≅(TpBL+0.5*TpC+0.5*TpSiL)+Δ₃−0.5*(TpSiL−2*Δ₄)

For the correlation comparison in accordance with the rules for obtaining the real and imaginary parts of signals, see the disclosure of the invention, of the approximately obtained signals for TpFL+0.5*TpC and TpBR+0.5*TpC, and respectively TpFR+0.5*TpC and TpBL+0.5*TpC and for FIG. 3, it then holds true that for the approximate signals resulting from adjacent correlation comparisons only the difference η₄−η₃ or η₂−η₁ hand respectively η₁−η₄ or η₃−η₂, after residual correction by the average value of the sum Δ₁+Δ₂+Δ₃+Δ₄, directly influences the residual resulting from this new correlation comparison.

The following downmix would likewise be obvious:

TpFL′=TpFL+0.5*TpFC+0.5*TpSiL+0.25*TpC

TpFR′=TpFR+0.5*TpFC+0.5*TpSiR+0.25*TpC

TpBL′=TpBL+0.5*TpBC+0.5*TpSiL+0.25*TpC

TpBR′=TpBR+0.5*TpBC+0.5*TpSiR+0.25*TpC

Consideration is then given to:

Δ₂−Δ₁=η₃−η₄=a₁

Δ₃−Δ₂=η₄−η₁=a₂

Δ₄−Δ₃=η₁−η₂=a₃

Δ₁−Δ₄=η₂−η₃=a₄

and accordingly

(Δ₂−Δ₁)+(Δ₃−Δ₂)=η₃−η₁=a₁+a₂

(Δ₃−Δ₂)+(Δ₄−Δ₃)=η₄−η₂=a₂+a₃

(Δ₄−Δ₃)+(Δ₁−Δ₄)=η₁−η₃=a₃+a₄

(Δ₁−Δ₄)+(Δ₂−Δ₁)=η₂−η₄=a₄+a₁

The same consideration as in the disclosure of the invention leads to

η₂=η₄+(a₄+a₁) or η₂=η₄−(a₂+a₃) and η₁=η₃+(a₃+a₄) or η₁=η₃−(a₁+a₂)

which simply means that no common residual can be assigned to the extraction of TpC in this case.

Such a downmix is accordingly possible, but not recommendable, unless a residual associated with the extraction of the TpC is concomitantly transmitted.

An alternative to the approximate extraction of the TpC by means of correlation comparison is the following downmix:

TpFL′=TpFL+(0.5*TpFC+0.5*TpC)+0.5*TpSiL

TpFR′=TpFR+(0.5*TpFC+0.5*TpC)+0.5*TpSiR

TpBL′=TpBL+0.5*TpBC+0.5*TpSiL

TpBR′=TpBR+0.5*TpBC+0.5*TpSiR

in which for the correlation comparison in accordance with the rules for obtaining the real and imaginary parts of signals, see the disclosure of the invention, between TpFL′ and TpFR′ directly (0.5*TpFC+0.5*TpC−2*Δ₁) is extracted, and a residual correction in the form described above can subsequently be carried out.

In actual fact, a localization between TpFC and TpC is beset psychoacoustically by great unsharpness, which can be utilized in a targeted manner:

Instead of a correlation comparison for extracting the TpC, by means of single or dual panning known from the prior art, the mapping direction or the mapping width of the exact or approximated signal (0.5*TpFC+0.5*TpC) is influenced such that it matches the original signal as much as possible, and an impression psychoacoustically comparable with the original signal thus arises. Consequently, only the parameters of the single or dual panning are transmitted instead of a spatial coding or a correlation comparison for obtaining the TpC in accordance with the rules for obtaining the real and imaginary parts of signals, see the disclosure of the invention.

If other spatial encodings and decodings are intended to be applied, such as, for instance, the so-called inverse coding, see above, they can be directly integrated into the above considerations:

By way of example, TpFC and TpC can advantageously be expressed by an inverse coding in accordance with FIG. 9, as already explained above, which can additionally be coupled with single or dual panning. The result is a precise, natural hearing impression on account of the psychoacoustic conditions.

TpFL′, TpFR′, TpBL′, TpBR′ and also, if appropriate, the average value Δ of all the residuals Δ₁, Δ₂, Δ₃, Δ₄ (and if need be a residual resulting from a correlation comparison, this in accordance with the rules for obtaining the real and imaginary parts of signals, see the disclosure of the invention, for determining TpC, or else the TpC signal itself) can be compressed, for example in an encoder, and subsequently decompressed, for example in a decoder, with the aid of a base audio codec that can be specifically adapted for this purpose (“tuning”), this for the purpose of efficient storage or transmission, see FIG. 6 (wherein an additional spatial encoding and decoding for example with the aid of the so-called inverse coding, or else single or dual panning can also take place in the present example).

Likewise, the systems described overall can make use of a Fourier transform already performed in the base audio coder, by which means the computational complexity required overall can be significantly decreased.

Exemplary Structure of an Encoder and Decoder for an NHK-22.2 Top Layer Signal Without TpC (See FIGS. 7 and 10 to 15):

Overall, the parameters assigned to the described coding, see FIG. 6, can be transmitted as header information, as data pulse or as permanent data stream, for example from an encoder to a decoder.

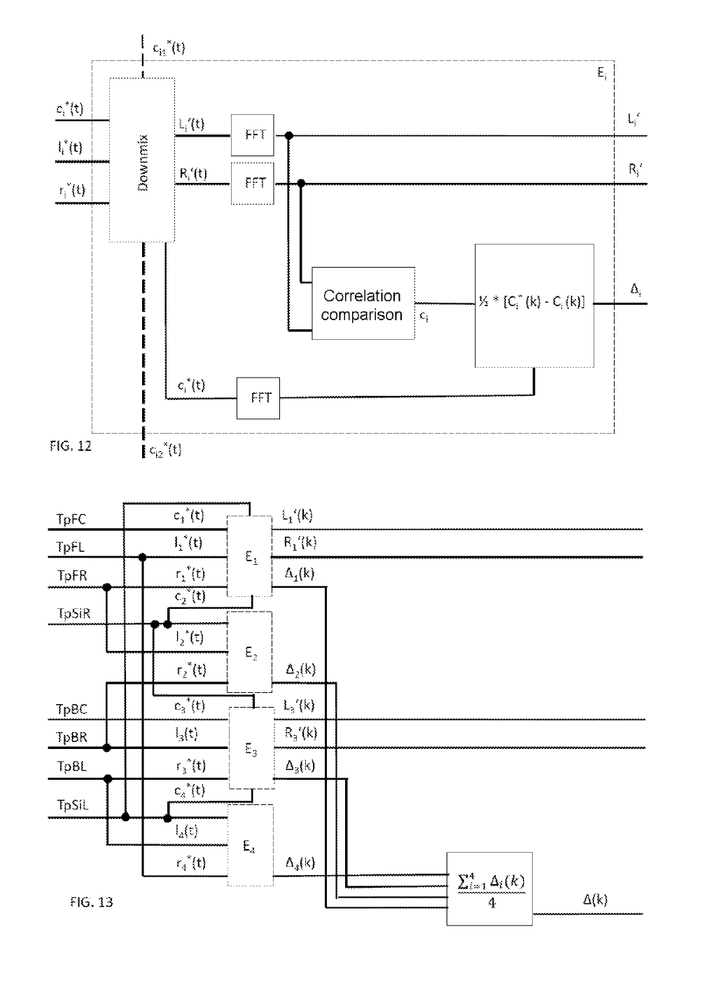

FIGS. 12 to 14 show a possible structure of an encoder and decoder for encoding and decoding an NHK-22.2 top layer signal without TpC:

In this case, FIG. 12 illustrates an encoder module Eᵢ, to which three adjacent input channels lᵢ*(t), cᵢ*(t) and rᵢ*(t) or optionally a further input channel cᵢ₁*(t) or a further input channel cᵢ₂*(t) are fed. From these three input channels, a downmix

Lᵢ′(t)=lᵢ*(t)+0.5*cᵢ*(t)

and

Rᵢ′(t)=rᵢ*(t)+0.5*cᵢ*(t)

or

Lᵢ′(t)=lᵢ*(t)+0.5*cᵢ*(t)+0.5*cᵢ₁*(t)

and

Rᵢ′(t)=rᵢ*(t)+0.5*cᵢ*(t)+0.5*Cᵢ₂*(t)

is calculated, wherein, if appropriate, cᵢ₁*(t) and cᵢ₂*(t) denote the respectively closest center channel (accordingly TpFC or TpSiR or TpBC or TpSiL) not admixed with both downmix channels Lᵢ′(t) and Rᵢ′(t). Afterward, a respective Fast Fourier Transform (FFT) is performed for both downmix channels Lᵢ′(t) and Rᵢ′(t). They firstly yield the output channels of the encoder module and, secondly, there is applied to these a correlation comparison in accordance with the rules for obtaining the real and imaginary parts of signals, see the disclosure of the invention. Equally, a Fast Fourier Transform (FFT) is likewise performed for the input channel cᵢ′(t). The residual Δᵢ is then determined in accordance with the formula

Δᵢ(k)=½*[Cᵢ*(k)−Cᵢ(k)]

which likewise constitutes an output signal of the encoder module. (The system described can be modified in accordance with the disclosure of the invention by addition of further input signals, for example in line with FIG. 14, such that the residual Δᵢ can also be calculated in accordance with the formulae

Δ=Lᵢ−Lᵢ*

or

Δ=Rᵢ−Rᵢ*.)

FIG. 13 then illustrates the overall structure of the encoder. Four encoder modules E₁, E₂, E₃, E₄ are assigned the following input signals:

TpFC=c₁*(t)

TpFL=l₁*(t)=r₄*(t)

TpFR=rₗ*(t)=l₂*(t)

TpSiR=c₂*(t)=c₁₂*(t)=c₃₁*(t)

TpBC=c₃*(t)

TpBR=r₂*(t)=l₃*(t)

TpBL=r₃*(t)=l₄*(t)

TpSiL=c₄*(t)=c₁₁*(t)=c₃₂*(t)

The encoder module Eₗ supplies the output signals L₁′(k), R₁′(k), Δ₁(k). The encoder module E₂ supplies the output signal Δ₂(k). The encoder module E₃ supplies the output signals L₃′(k), R₃′(k), Δ₃(k). The encoder module E₄ supplies the output signal Δ₄(k).

While the output signals L₁′(k), R₁′(k) and L₃′(k), R₃′(k) simultaneously constitute output signals of the encoder, the average value Δ(k) of the residuals Δ₂(k), Δ₂(k), Δ₃(k), Δ₄(k) is finally calculated. Said average value likewise constitutes an output signal of the encoder.

FIG. 14 then shows the structure of the decoder:

In said decoder, a first correlation comparison takes place in accordance with the rules for obtaining the real and imaginary parts of signals, see the disclosure of the invention, with the aid of the left input signal L₁′(k) and the right input signal R₁′(k), wherein only C₁(k) is calculated.

In said decoder, a second correlation comparison takes place in accordance with the rules for obtaining the real and imaginary parts of signals, see the disclosure of the invention, with the aid of the left input signal R₁′(k) and the right input signal L₃′(k), wherein both C₂(k) and L₂(k) are calculated.

In said decoder, a third correlation comparison takes place in accordance with the rules for obtaining the real and imaginary parts of signals, see the disclosure of the invention, with the aid of the left input signal L₃′(k) and the right input signal R₃′(k), wherein both C₃(k) and L₃(k) are calculated.

In said decoder, a fourth correlation comparison takes place in accordance with the rules for obtaining the real and imaginary parts of signals, see the disclosure of the invention, with the aid of the left input signal R₃′(k) and the right input signal Lₗ′(k), wherein both C₄(k) and L₄(k) and R₄(k) are calculated.

With the aid of the input signal for the frequency-dependent residual Δ(k), the following channels described in a frequency-dependent manner are then calculated:

C₁(k)+2Δ(k)≅c₁*(k)

C₂(k)+2Δ(k)≅c₂*(k)

L₂(k)−C₁(k)−2Δ(t)≅l₂*(k)

C₃(k)+2Δ(k)≅c₃*(k)

L₃(k)−C₂(k)−2Δ(k)≅l₃*(k)

C₄(k)+2Δ(k)≅c₄*(k)

L₄(k)−C₃(k)−2Δ(k)≅l₄*(k)

R₄(k)−C₁(k)−2Δ(k)≅r₄*(k)

An Inverse Fast Fourier Transform (IFFT) is then applied to each of these frequency-dependent channels.

The following output signals thus arise for the decoder, which approximately represent the input signals of the same name of the encoder, specifically:

c₁(t)+2Δ(t)≅c₁*(t)=TpFC

c₂(t)+2Δ(t)≅c₂*(t)=TpSiR

l₂(t)−c₁(t)−2Δ(t)≅l₂*(t)=TpFR

c₃(t)+2Δ(t)≅c₃*(t)=TpBC

l₃(t)−c₂(t)−2Δ(t)≅l₃*(t)=TpBR

c₄(t)+2Δ(t)≅c₄*(t)=TpSiL

l₄(t)−c₃(t)−2Δ(t)≅l₄*(t)=TpBL

r₄(t)−c₁(t)−2Δ(t)≅r₄*(t)=TpFL

Concluding Observations:

Principles presented overall are algorithmically arbitrarily extendable and thus allow overall the efficient compression of multi-signals of arbitrary, indeed very high, order with the aid of a downmix, this for the purpose of efficient storage or transmission, for example between an encoder and a decoder.

Claims 9 to 42 use the method as claimed in claims 1 to 8 for determining at least one common signal and/or a first individual signal and/or a second individual signal from two input signals. Alternatively any other method for determining a common signal, a first individual signal and a second individual signal from two input signals could be used in claims 9 to 42.

Furthermore, the storage and/or transmission of data (e.g. a file or other storage means or transmission means) with a downmix signal and/or with a residual averaged from a plurality of residuals and/or with a panning parameter set and/or with parameters of an inverse coding is also intended to be disclosed here.

A multichannel signal having n channels can in turn contain a further multichannel signal having n−1>2 channels, a further multichannel signal having n−2>2 channels, etc.

Conversely, from a multi-signal having n>2 or n−1>2 or n−2>2, etc. channels, a further multichannel signal of higher order can in turn be derived.

What is claimed is:

1. A method for extracting at least one output signal from two input signals in a signal processor;
characterized by
providing first frequency-dependent input signal components (Lᵢ′(k)) and second frequency-dependent input signal components (Rᵢ′(k)) for a multiplicity of frequencies;
comparing the signs of the first frequency-dependent input signal component (Lᵢ′(k)) and of the second frequency-dependent input signal component (Rᵢ′(k)) of one frequency (k) of the multiplicity of frequencies;
determining at least one from a first frequency-dependent individual signal component (Lᵢ(k)) of a first individual signal, a second frequency-dependent individual signal component (Rᵢ(k)) of a second individual signal and a frequency-dependent common signal component (Cᵢ(k)) of the frequency (k) of the multiplicity of frequencies on the basis of the sign comparison;
determining the at least one output signal on the basis of at least one of the first frequency-dependent individual signal components (Lᵢ(k)) of the multiplicity of frequencies the second frequency-dependent individual signal components (Rᵢ(k)) of the multiplicity of frequencies and the frequency-dependent common signal components (Cᵢ(k)) of the multiplicity of frequencies.

2. The method as claimed in claim 1, wherein the step of determining at least one from the first frequency-dependent individual signal component (Lᵢ(k)), the second frequency-dependent individual signal component (Rᵢ(k)) and the frequency-dependent common signal component (Cᵢ(k)) of the frequency (k) comprises at least one of the following three steps:
given an identical sign of the first and second frequency-dependent input signal components (Lᵢ′(k), Rᵢ′(k)) of the frequency (k): determining the frequency-dependent common signal component (Cᵢ(k)) of the frequency k on the basis of that one of the first and second frequency-dependent input signal components (Lᵢ′(k), Rᵢ′(k)) of the frequency (k) which has the smaller absolute value; and/or
given an identical sign of the first and second frequency-dependent input signal components (Lᵢ′(k), Rᵢ′(k)) of the frequency (k): if the first frequency-dependent input signal component (Lᵢ′(k)) has a larger absolute value than the second frequency-dependent input signal component (Rᵢ′(k)), determining the first frequency-dependent individual signal component (Lᵢ(k)) of the frequency (k) on the basis of the difference between the first frequency-dependent input signal component (Lᵢ′(k)) and the second frequency-dependent input signal component (Rᵢ′(k)); given a non-identical sign of the first and second frequency-dependent input signal components (Lᵢ′(k), Rᵢ′(k)) of the frequency (k): determining the first frequency-dependent individual signal component (Lᵢ(k)) of the frequency (k) on the basis of the first frequency-dependent input signal component (Lᵢ′(k)); and given an identical sign of the first and second frequency-dependent input signal components (Lᵢ′(k), Rᵢ′(k)) of the frequency (k): if the first frequency-dependent input signal component (Lᵢ′(k)) has a smaller absolute value than the second frequency-dependent input signal component (Rᵢ′(k)), determining the second frequency-dependent individual signal component (Rᵢ(k)) of the frequency (k) on the basis of the difference between the second frequency-dependent input signal component (Rᵢ′(k)) and the first frequency-dependent input signal component (Lᵢ′(k)); given a non-identical sign of the first and second frequency-dependent input signal components (Lᵢ′(k), Rᵢ′(k)) of the frequency (k): determining the second frequency-dependent individual signal component (Rᵢ(k)) of the frequency (k) on the basis of the second frequency-dependent input signal component (Rᵢ′(k)).

3. The method as claimed in claim 2, wherein the step of determining at least one from the first frequency-dependent individual signal component (Lᵢ(k)), the second frequency-dependent individual signal component (Rᵢ(k)) and the frequency-dependent common signal component (Cᵢ(k)) of the frequency (k) comprises at least one of the following three steps:
given an identical sign of the first and second frequency-dependent input signal components (Lᵢ′(k), Rᵢ′(k)) of the frequency (k):
determining that one of the first and second frequency-dependent input signal components (Lᵢ′(k), Rᵢ′(k)) of the frequency which has the smaller absolute value as a frequency-dependent common signal component (Cᵢ(k)) of the frequency k; given a non-identical sign of the first and second frequency-dependent input signal components (Lᵢ′(k), Rᵢ′(k)) of the frequency (k): zeroing the frequency-dependent common signal component (Cᵢ(k)) of the frequency (k); and/or
given an identical sign of the first and second frequency-dependent input signal components (Lᵢ′(k), Rᵢ′(k)) of the frequency (k): if the first frequency-dependent input signal component (Lᵢ′(k)) has a larger absolute value than the second frequency-dependent input signal component (Rᵢ′(k)), determining the first frequency-dependent individual signal component (Lᵢ(k)) of the frequency (k) as a difference between the first frequency-dependent input signal component (Lᵢ′(k)) and the second frequency-dependent input signal component (Rᵢ′(k)), otherwise determining the first frequency-dependent individual signal component (Lᵢ(k)) of the frequency (k) as zero; given a non-identical sign of the first and second frequency-dependent input signal components (Lᵢ′(k), Rᵢ′(k)) of the frequency (k): determining the first frequency-dependent individual signal component (Lᵢ(k)) of the frequency (k) as the first frequency-dependent input signal component (Lᵢ(k)); and
given an identical sign of the first and second frequency-dependent input signal components (Lᵢ′(k), Rᵢ′(k)) of the frequency (k): if the first frequency-dependent input signal component (Lᵢ′(k)) has a smaller absolute value than the second frequency-dependent input signal component (Rᵢ′(k)), determining the second frequency-dependent individual signal component (Rᵢ(k)) of the frequency (k) as a difference between the second frequency-dependent input signal component (Rᵢ′(k)) and the first frequency-dependent input signal component (Lᵢ′(k)), otherwise determining the second frequency-dependent individual signal component (Rᵢ(k)) of the frequency (k) as zero; given a non-identical sign of the first and second frequency-dependent input signal components (Lᵢ′(k), Rᵢ′(k)) of the frequency (k): determining the second frequency-dependent individual signal component (Rᵢ(k)) of the frequency (k) as the second frequency-dependent input signal component (Rᵢ′(k)).

4. The method as claimed claim 1, wherein the first and second frequency-dependent input signal components (Rᵢ′(k), Lᵢ′(k)) are complex-valued and the step of determining at least one from the first frequency-dependent individual signal component (Lᵢ(k)), the second frequency-dependent individual signal component (Rᵢ(k)) and the frequency-dependent common signal component (Cᵢ(k)) of the frequency (k) is carried out separately once for the real part and/or once for the imaginary part.

5. The method as claimed in claim 1, wherein providing first frequency-dependent input signal components (L′(k)) and second frequency-dependent input signal components (R′(k)) comprises Fourier transforming the first input signal from the time domain to the frequency domain and the second input signal from the time domain to the frequency domain.

6. The method as claimed in claim 1, wherein the at least one output signal consists of frequency-dependent output signal components.

7. The method as claimed in claim 1, wherein the at least one output signal is formed by inverse Fourier transformation of frequency-dependent signal components formed on the basis of the first frequency-dependent individual signal components (Lᵢ(k)) of a multiplicity of frequencies and/or the second frequency-dependent individual signal components (Rᵢ(k)) of a multiplicity of frequencies and/or the frequency-dependent common signal components (Cᵢ(k)) of a multiplicity of frequencies.

8. The method as claimed in claim 1, wherein the step of comparing the signs of the frequency and of determining at least one from a first frequency-dependent individual signal component (Lᵢ(k)) of a first individual signal, a second frequency-dependent individual signal component (Rᵢ(k)) of a second individual signal and a frequency-dependent common signal component (Cᵢ(k)) of the frequency (k) on the basis of the sign comparison is carried out in each case for the multiplicity of frequencies.

9-35. (canceled)

36. A computer program designed, upon execution on a processor, to perform for extracting at least one output signal from two input signals the method steps of:
providing first frequency-dependent input signal components (Lᵢ′(k)) and second frequency-dependent input signal components (Rᵢ′(k)) for a multiplicity of frequencies;
comparing the signs of the first frequency-dependent input signal component (Lᵢ′(k)) and of the second frequency-dependent input signal component (Rᵢ′(k)) of one frequency (k) of the multiplicity of frequencies;
determining at least one from a first frequency-dependent individual signal component (Lᵢ(k)) of a first individual signal, a second frequency-dependent individual signal component (Rᵢ(k)) of a second individual signal and a frequency-dependent common signal component (C(k)) of the frequency (k) of the multiplicity of frequencies on the basis of the sign comparison;
determining the at least one output signal on the basis of at least one of the first frequency-dependent individual signal components (Lᵢ(k)) of the multiplicity of frequencies, the second frequency-dependent individual signal components (Rᵢ(k)) of the multiplicity of frequencies and the frequency-dependent common signal components (Cᵢ(k)) of the multiplicity of frequencies.

37. A device for extracting at least one output signal from two input signals comprising;
a receiving device for receiving first frequency-dependent input signal components (Lᵢ′(k)) and second frequency-dependent input signal components (Rᵢ′(k)) for a multiplicity of frequencies;
a comparison device for comparing the signs of the first frequency-dependent input signal component (Lᵢ′(k)) and of the second frequency-dependent input signal component (Rᵢ′(k)) of one frequency (k) of the multiplicity of frequencies;
a calculation means for determining at least one from a first frequency-dependent individual signal component (Lᵢ(k)) of a first individual signal, a second frequency-dependent individual signal component (Rᵢ(k)) of a second individual signal and a frequency-dependent common signal component (Cᵢ(k)) of the frequency (k) for the multiplicity of frequencies on the basis of the sign comparison; and
the calculation device is further designed for determining the at least one output signal on the basis of the first frequency-dependent individual signal components (Lᵢ(k)) of the multiplicity of frequencies and/or the second frequency-dependent individual signal components (Rᵢ(k)) of the multiplicity of frequencies and/or the frequency-dependent common signal components (Cᵢ(k)) of the multiplicity of frequencies.

38-42. (canceled)

43. The device as claimed in claim 37, wherein the calculation means is configured for at least one of the following three functions:
given an identical sign of the first and second frequency-dependent input signal components (Lᵢ′(k), Rᵢ′(k)) of the frequency (k): determining the frequency-dependent common signal component (Cᵢ(k)) of the frequency k on the basis of that one of the first and second frequency-dependent input signal components (Lᵢ′(k), Rᵢ′(k)) of the frequency (k) which has the smaller absolute value;
given an identical sign of the first and second frequency-dependent input signal components (Lᵢ′(k), Rᵢ′(k)) of the frequency (k): if the first frequency-dependent input signal component (Lᵢ′(k)) has a larger absolute value than the second frequency-dependent input signal component (Rᵢ′(k)), determining the first frequency-dependent individual signal component (Lᵢ(k)) of the frequency (k) on the basis of the difference between the first frequency-dependent input signal component (Lᵢ′(k)) and the second frequency-dependent input signal component (Rᵢ′(k)); given a non-identical sign of the first and second frequency-dependent input signal components (Lᵢ′(k), Rᵢ′(k)) of the frequency (k): determining the first frequency-dependent individual signal component (Lᵢ(k)) of the frequency (k) on the basis of the first frequency-dependent input signal component (Lᵢ′(k)); and
given an identical sign of the first and second frequency-dependent input signal components (Lᵢ′(k), Rᵢ′(k)) of the frequency (k): if the first frequency-dependent input signal component (Lᵢ′(k)) has a smaller absolute value than the second frequency-dependent input signal component (Rᵢ′(k)), determining the second frequency-dependent individual signal component (Rᵢ(k)) of the frequency (k) on the basis of the difference between the second frequency-dependent input signal component (Rᵢ′ (k)) and the first frequency-dependent input signal component (Lᵢ′ (k)); given a non-identical sign of the first and second frequency-dependent input signal components (Lᵢ′(k), Rᵢ′(k)) of the frequency (k): determining the second frequency-dependent individual signal component (Rᵢ(k)) of the frequency (k) on the basis of the second frequency-dependent input signal component (Rᵢ′(k)).

44. The device as claimed in claim 43, wherein the calculation means is configured for at least one of the following three functions:
given an identical sign of the first and second frequency-dependent input signal components (Lᵢ′(k), Rᵢ′(k)) of the frequency (k): determining that one of the first and second frequency-dependent input signal components (Lᵢ′(k), Rᵢ′(k)) of the frequency which has the smaller absolute value as a frequency-dependent common signal component (Cᵢ(k)) of the frequency k; given a non-identical sign of the first and second frequency-dependent input signal components (Lᵢ′(k), Rᵢ′(k)) of the frequency (k): zeroing the frequency-dependent common signal component (Cᵢ(k)) of the frequency (k);
given an identical sign of the first and second frequency-dependent input signal components (Lᵢ′(k), Rᵢ′(k)) of the frequency (k): if the first frequency-dependent input signal component (Lᵢ′(k)) has a larger absolute value than the second frequency-dependent input signal component (Rᵢ′(k)), determining the first frequency-dependent individual signal component (Lᵢ(k)) of the frequency (k) as a difference between the first frequency-dependent input signal component (Lᵢ′(k)) and the second frequency-dependent input signal component (Rᵢ′(k)), otherwise determining the first frequency-dependent individual signal component (Lᵢ(k)) of the frequency (k) as zero; given a non-identical sign of the first and second frequency-dependent input signal components (Lᵢ′(k), Rᵢ′(k)) of the frequency (k): determining the first frequency-dependent individual signal component (Lᵢ(k)) of the frequency (k) as the first frequency-dependent input signal component (Lᵢ(k)); and
given an identical sign of the first and second frequency-dependent input signal components (Lᵢ′(k), Rᵢ′(k)) of the frequency (k): if the first frequency-dependent input signal component (Lᵢ′(k)) has a smaller absolute value than the second frequency-dependent input signal component (Rᵢ′(k)), determining the second frequency-dependent individual signal component (Rᵢ(k)) of the frequency (k) as a difference between the second frequency-dependent input signal component (Rᵢ′(k)) and the first frequency-dependent input signal component (Lᵢ′(k)), otherwise determining the second frequency-dependent individual signal component (Rᵢ(k)) of the frequency (k) as zero; given a non-identical sign of the first and second frequency-dependent input signal components (Lᵢ′(k), Rᵢ′(k)) of the frequency (k): determining the second frequency-dependent individual signal component (Rᵢ(k)) of the frequency (k) as the second frequency-dependent input signal component (Rᵢ′(k)).

45. The device as claimed claim 37, wherein
the first and second frequency-dependent input signal components (Rᵢ′(k), Lᵢ′(k)) are complex-valued,
the comparison device is configured to
compare the real part signs of the real part of first frequency-dependent input signal component (Lᵢ′(k)) and of the real part of the second frequency-dependent input signal component (Rᵢ′(k)) of one frequency (k) of the multiplicity of frequencies and
compare the imaginary part signs of the imaginary parts of first frequency-dependent input signal component (Lᵢ′(k)) and of the imaginary parts of the second frequency-dependent input signal component (Rᵢ′(k)) of one frequency (k) of the multiplicity of frequencies,
the calculation means is configured to
determine at least one from a real first frequency-dependent individual signal component (Lᵢ(k)) of a first individual signal, a real second frequency-dependent individual signal component (Rᵢ(k)) of a second individual signal and a real frequency-dependent common signal component (Cᵢ(k)) of the frequency (k) for the multiplicity of frequencies on the basis of the real part sign comparison;
determine at least one from an imaginary first frequency-dependent individual signal component (Lᵢ(k)) of a first individual signal, an imaginary second frequency-dependent individual signal component (Rᵢ(k)) of a second individual signal and an imaginary frequency-dependent common signal component (Cᵢ(k)) of the frequency (k) for the multiplicity of frequencies on the basis of the imaginary part sign comparison; and
determine the at least one output signal on the basis of at least one of the following:
the combination of the real first frequency-dependent individual signal components (Lᵢ(k)) and the imaginary first frequency-dependent individual signal components (Lᵢ(k)) of the multiplicity of frequencies,
the combination of the real second frequency-dependent individual signal components (Rᵢ(k)) and the imaginary second frequency-dependent individual signal components (Lᵢ(k)) of the multiplicity of frequencies and
the combination of the real frequency-dependent common signal components (Cᵢ(k)) of the multiplicity of frequencies and the imaginary frequency-dependent common signal components (Lᵢ(k)).

46. The device as claimed in claim 37, wherein providing first frequency-dependent input signal components (L′(k)) and second frequency-dependent input signal components (R′(k)) comprises Fourier transforming the first input signal from the time domain to the frequency domain and the second input signal from the time domain to the frequency domain.

47. The device as claimed in claim 37, wherein the at least one output signal consists of frequency-dependent output signal components.

48. The device as claimed in claim 37, wherein one of the at least one output signal is formed by inverse Fourier transformation of frequency-dependent signal components formed on the basis of the first frequency-dependent individual signal components (Lᵢ(k)) of a multiplicity of frequencies or the second frequency-dependent individual signal components (Rᵢ(k)) of a multiplicity of frequencies or the frequency-dependent common signal components (Cᵢ(k)) of a multiplicity of frequencies.

49. The device as claimed in claim 37, wherein the step of comparing the signs of the frequency and of determining at least one from a first frequency-dependent individual signal component (Lᵢ(k)) of a first individual signal, a second frequency-dependent individual signal component (Rᵢ(k)) of a second individual signal and a frequency-dependent common signal component (Cᵢ(k)) of the frequency (k) on the basis of the sign comparison is carried out in each case for the multiplicity of frequencies.
